(19) United States
(12) Patent Application Publication
(10) Pub. No.: US 2021/0073108 A1
(43) Pub. Date: Mar. 11, 2021

(54) VIRTUALIZED DEVICE-BASED TEST SYSTEM AND METHOD THEREOF

(71) Applicants: Inventec (Pudong) Technology Corporation, Shanghai (CN); INVENTEC CORPORATION, Taipei (TW)

(72) Inventor: Lei WANG, Shanghai (CN)

(73) Assignees: Inventec (Pudong) Technology Corporation, Shanghai (CN); INVENTEC CORPORATION, Taipei (TW)

(21) Appl. No.: 17/013,645

(22) Filed: Sep. 6, 2020

(30) Foreign Application Priority Data
Sep. 9, 2019 (CN) 2019108647718

(51) Int. Cl. G06F 11/36

(52) U.S. Cl. CPC G06F 11/3664; G06F 11/3688; G06F 11/3692

(57) ABSTRACT

The present disclosure relates to a virtualized device-based test system and method thereof. A virtual mobile device can be generated by the host at the test end, and a script file corresponding to the item to be tested is allowed to be established. When testing, the script file is executed to: simulate the touch operation, detect the display state and identify the text information by the basic functions; drive the browser of the virtual mobile device to perform webpage operations through an application programming interface (API) and control functions; then generate a log file according to the script file and the execution result of the webpage operations; and generate a test report according to the log file, the touch operation, the display state and the text information for transmission or display, so as to achieve the technical effect of improving the convenience of system testing.

### CROSS REFERENCE TO RELATED APPLICATION

This application claims the benefits of priority to Chinese Patent Application No. CN 201910864771.8, entitled “Virtualized Device-Based Test System and Method Thereof”, filed with CNIPA on Sep. 9, 2019, the contents of which are incorporated herein by reference in its entirety.

### BACKGROUND

### Field of Disclosure

The present disclosure relates to a test system and method, in particular, to a virtualized device-based test system and method thereof.

### Description of Related Arts

In recent years, with the popularization and vigorous development of the software industry, various software systems have sprung up, among which software systems with network functions are the most common.

Generally speaking, after a software system is completed, multiple tests are required to confirm that the functions are in line with expectations. In a test, various operations are usually performed manually and report mechanism is provided. When problems occur, it is immediately reported to the programmer for correction and adjustment. However, this method requires a lot of manpower and material resources, such as the need to configure the corresponding hardware and software devices. Therefore, this method is not convenient for system testing. In addition, the testing of the software system is easy to make mistakes due to its dullness.

In view of this, some manufacturers put forward the technical means of automated testing, which presets corresponding program instructions on the software system, such as self-inspection instructions, and replaces manual testing by executing program instructions. However, this method is difficult to apply in a complex test environment. For example, in a process that requires simultaneous testing with a mobile device, the program instructions used for testing on the software system cannot truly reflect various operations carried out on the mobile devices and the impact on the software system. Therefore, system testing is still not convenient.

In summary, it can be known that system testing is not convenient for a long time, so it is necessary to propose an improved technical means to solve this problem.

### SUMMARY

The present disclosure provides a virtualized device-based test system and method thereof.

First, the present disclosure describes a virtualized device-based test system, including a host to be tested and a host at a test end. The host to be tested executes a web-based system to be tested, and allows login through a webpage. The host at the test end is connected with the host to be tested through a network, the host at the test end includes a simulating module, a setting module, a test module, and a generating module. The simulating module generates a virtual mobile device by executing the mobile device simulation program, a plurality of basic functions are preset in the mobile device simulation program, the basic functions include simulating the touch operation of the user in the virtual mobile device, detecting the display state of the virtual mobile device and identifying the text information displayed by the virtual mobile device. The setting module is connected to the simulating module, and pre-establishes an item to be tested and a corresponding script file thereof on the host at the test end, and the script file includes a basic function for testing the item to be tested; the test module is connected to the setting module, executes a script file to test the item to be tested during the test, controls the browser of the virtual mobile device to log in to the host to be tested through an application programming interface (API), executes a plurality of control functions, the control functions include continuously locating webpage elements in the browser, and drives the browser to perform webpage operations according to the located webpage elements; the generating module is connected to the test module for continuously recording the script file and the execution result of the webpage operation to generate a log file, and generating a test report for transmission or display according to the log file, the touch operation, the display state, and the text information.

In addition, the present disclosure describes a virtualized device-based test method, which is applied to a network environment having a host to be tested and a host at the test end. The method includes: performing, via the host to be tested, a web-based test system, and allowing the host at the test end to log in through a webpage; executing, via the host at the test end, a mobile device simulation program to generate a virtual mobile device, a plurality of basic functions are preset in the mobile device simulation program, the basic functions include simulating the touch operation of the user in the virtual mobile device, detecting the display state of the virtual mobile device and identifying the text information displayed by the virtual mobile device; pre-establishing an item to be tested and a corresponding script file on the host at the test end, the script file includes a basic function for testing the item to be tested; during the test, executing, via the host at the test end, the script file to test the item to be tested during the test, controlling, via an application programming interface(API), the browser of the virtual mobile device to log in to the host to be tested, and executing a plurality of control functions, the control functions include continuously locating webpage elements in the browser, and driving the browser to perform webpage operations according to the located webpage elements; continuously recording, via the host at the test end, the script file and the execution result of the webpage operation to generate a log file, and generating a test report for transmission or display according to the log file, the touch operation, the display state, and the text information.

The system and method described by the present disclosure are shown above. The difference between the present disclosure and the prior art is that the present disclosure generates a virtual mobile device by the host at the test end, and allows a script file corresponding to the item to be tested to be established. When testing, the script file is executed to simulate the touch operation, detect the display state and identify the text information by the basic functions; drive the browser of the virtual mobile device to perform webpage operations through an application programming interface (API) and control functions; then generate a log file according to the script file and the execution result of the webpage operations; and generate a test report according to the log file, the touch operation, the display state and the text information for transmission or display.

Through the above technical means, the present disclosure can achieve the technical effect of improving the convenience of system testing.

### BRIEF DESCRIPTION OF THE DRAWINGS

FIG. 1 is the schematic block diagram of a virtualized device-based test system according to the present disclosure.

FIG. 2 is the flow chart of a virtualized device-based test method according to the present disclosure.

FIG. 3A and FIG. 3B are schematic diagrams of applying the present disclosure for system testing.

FIG. 4 is a schematic diagram of applying the present disclosure to simulate the scanning of a two-dimensional barcode.

### DESCRIPTION OF REFERENCE NUMERALS

110 Host to be tested
120 Host at the test end
121 Simulating module
122 Setting module
123 Test module
124 Generating module
300 Virtual mobile device
311 Return button
312 Screen-the-work-order button
313 Scan-the-barcode button
321 Input block
322 Confirm button
410 Analysis button
420 Virtual camera component
421 Two-dimensional barcode

### DETAILED DESCRIPTION OF THE PREFERRED EMBODIMENTS

The embodiments of the present disclosure will be described in detail below with reference to the drawings and embodiments, so that the implementation process of how the present disclosure applies technical means to solve technical problems and achieve technical effects can be fully understood and implemented accordingly.

Before describing the virtualization device-based test system and the method thereof in the present disclosure, the network environment to which the present disclosure is applied is described. The network environment includes a wired network or a wireless network or a combination of the two, so that the host to be tested and the host at the test end can communicate with each other. The wired network can be connected by telephone wire, twisted pair, cable, optical fiber, or the like. The wireless network can be implemented by a wireless communication technology such as Bluetooth, Wi-Fi, LoRa, ZigBee, Constrained Application Protocol (CoAP) or Message Queuing Telemetry Transport (MQTT). In practical implementation, both the host to be tested and the host at the test end can be implemented by using a computer device, such as a personal computer, a notebook computer, a tablet computer, a smart mobile device, a server, and the like.

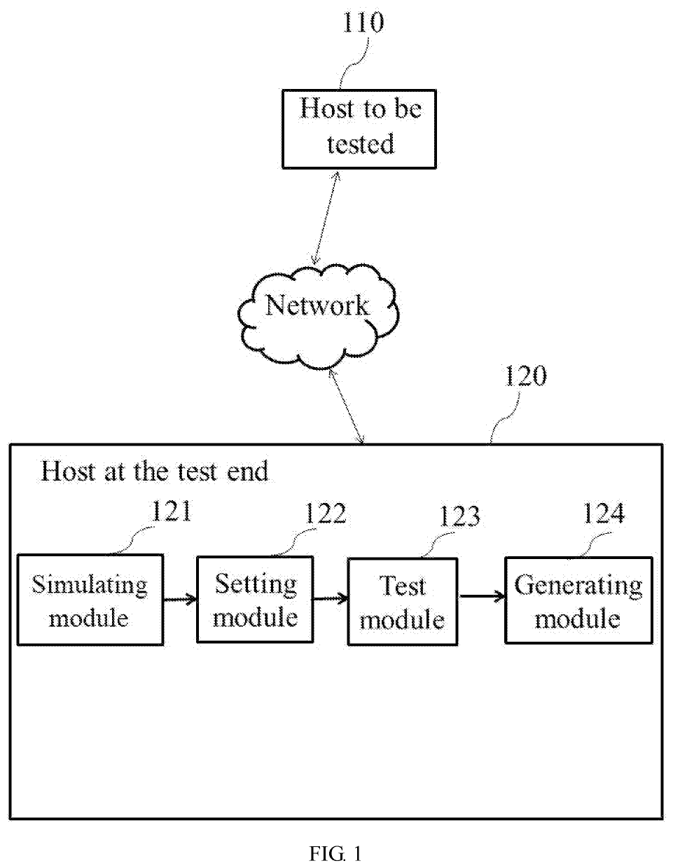

The virtualized device-based test system and method thereof of the present disclosure are further explained by drawings as follows. Referring to FIG. 1, FIG. 1 is the schematic block diagram of a virtualized device-based test system according to the present disclosure. The system includes: a host to be tested 110 and a host at a test end 120. The host to be tested 110 executes a web-based system to be tested, such as a spare parts management system, and allows login through a webpage.

For the host at the test end 120, it is connected to the host to be tested 110 through a network. The host at the test end 120 includes a simulating module 121, a setting module 122, a test module 123, and a generating module 124. The simulating module 121 executes a mobile device simulation program to generate a virtual mobile device, and preset a plurality of basic functions in the mobile device simulation program. The basic functions include simulating the touch operation of the user in the virtual mobile device, detecting the display state of the virtual mobile device and identifying the text information displayed by the virtual mobile device. In an exemplary embodiment, the mobile device simulation program may be implemented by using MuMu simulator, Android simulator, or other similar simulators, to produce virtual mobile devices that simulate mobile phones or personal digital assistant (PDA). The virtual mobile devices can be automatically controlled by performing basic functions. For example, the basic function mouseClick(x, y) can be used to simulate a touch operation (also called a cursor click) on a virtual mobile device, where x represents the X coordinate value of the selected position and y represents the Y coordinate value of the selected position; The display state of the virtual mobile device can be detected by the basic function scanDisplay( ); The basic function ocrText( ) can be used to identify text information displayed by the virtual mobile device, and so on. In addition, the basic functions may further include simulating a network attack for security testing, simulating a load for performance testing, and simulating heavy network traffic and user operations for stress testing and the like. In particular, the mobile device simulation program may also establish a virtual imaging component in the generated virtual mobile device. The virtual imaging component may perform image analysis on the two-dimensional barcode displayed in the virtual mobile device, to obtain the information embedded in the two-dimensional barcode. In other words, this method can simulate scanning the two-dimensional barcode to obtain the same result as scanning the two-dimensional barcode using a physical imaging component. In addition, the virtual imaging component allows to generate the required two-dimensional barcode under the control of the test module 123, thus controls the test process to proceed as expected. For example: when a sequence number (e.g., “SMTLINE01-AO1-001”) needs to be entered at a certain step in the automated test process, the virtual imaging component is controlled by the test module 123 to produce a two-dimensional barcode embedded with the sequence number “SMTLINE01-AO1-001”, so as to provide the test process with simulated scanned two-dimensional barcode and obtain the sequence number, so that the test process can be executed as expected.

The setting module 122 is connected to the simulating module 121, and is used to pre-establish an item to be tested and a corresponding script file thereof on the host at the test end 120. The script file includes a basic function for testing the item to be tested. In an exemplary embodiment, the script file is written by a script language, which is a programming language for controlling the program, and is usually stored with “ASCII” characters. Taking the above basic functions as an example, the script file may include a series of basic functions for implementing a series of corresponding operations on the virtual mobile device for testing the item to be tested. For example, the item to be tested is whether a preset text appears when a coordinate position is clicked. Then, the script file corresponding to the item to be tested would include the basic functions mouseClick(x, y) and ocrText( ) for sequentially simulating operations such as clicking the virtual mobile device and identifying the characters appeared.

The test module 123 is connected to the setting module 122. During the test, the test module 123 executes a script file to test the item to be tested, controls the browser of the virtual mobile device to log in to the host to be tested 110 through an application programming interface, and executes a plurality of control functions. The control functions include continuously locating webpage elements in the browser, and driving the browser to perform webpage operations according to the located webpage elements. In an exemplary embodiment, the control functions are a set of program instructions used to control the browser to perform corresponding actions. For example, controlling the browser to log in to the webpage, performing various operations on the webpage, and the like. The difference between the control functions and basic function is that the basic functions control the virtual mobile device, while the control functions control the browser of the virtual mobile device. In addition, before the host at the test end 120 tests the item to be tested, all parameters of database data, configuration files, environment parameters, basic functions and control functions in host at the test end 120 will be initialized to ensure that the result of each test is not affected by other factors.

The generating module 124 is connected to the test module 123 for continuously recording t the script file and the execution result of the webpage operation, so as to generate a log file, and generate a test report for transmission or display according to the log file, the touch operation, the display state, and the text information. In an exemplary embodiment, the log file records the information or events generated during executing the script file and webpage operations, such as a feedback of a success or error message. In addition, the generating module 124 records the touch operation, display state, and text information while generating information or events, so that the recorded data is collectively used as a test report. In addition, in an exemplary embodiment, the test report may be embedded in at least one of the email, the instant message and the webpage file, and transmitted to the mobile device through the network for display.

In particular, the modules of the present disclosure may be implemented in various manners, including software, hardware, or any combination thereof. For example, in some embodiments, modules may be implemented using either software or hardware. In addition, the present disclosure may also be implemented partially or completely based on hardware. For example, one or more modules in the system may be implemented through an integrated circuit chip, a system on chip (SoC), a complex programmable logic device (CPLD), a field programmable gate array (FPGA), etc. The disclosure may be a system, method and/or computer program. The computer program may include a computer readable storage media containing computer readable program instructions for enabling the processor to realize various aspects of the present disclosure. The computer readable storage media may be a physical device that can maintain and store instructions used by the instruction execution device. The computer readable storage medium may be, but is not limited to, an electrical storage device, a magnetic storage device, an optical storage device, an electromagnetic storage device, a semiconductor storage device, or any suitable combination of the foregoing. More specific examples (non-exhaustive lists) of computer readable storage media include hard disks, random access memories, read-only memories, flash memories, optical disks, floppy disks, and any suitable combination of the above. A computer readable storage medium used herein is not to be interpreted as a transient signal itself, such as a radio wave or other freely propagating electromagnetic wave, an electromagnetic wave propagating through a waveguide or other transmission medium (eg, an optical signal through a fiber optic cable), or an electrical signal transmitted over a wire. Additionally, the computer readable program instructions described herein may be downloaded from a computer readable storage medium to various computing/processing devices, or downloaded to an external computer device or an external storage device over a network, such as internet, regional network, wide area network, and/or wireless network. The network may include copper transmission cables, fiber optic transmission, wireless transmission, routers, firewalls, exchanger, concentrators, and/or gateways. The network card or network interface in each computing/processing device receives computer readable program instructions from the network and forwards the computer readable program instructions for storage in a computer readable storage media in each computing/processing device. Computer program instructions for performing the operations of the present disclosure may be combined language instructions, instruction set architecture instructions, machine instructions, machine related instructions, microinstructions, firmware instructions, or source code/object code written in one programming language or a combination of programming languages. The programming languages include object-oriented programming languages, such as Common Lisp, Python, C++, Objective-C, Smalltalk, Delphi, Java, Swift, C#, Perl, Ruby, PHP, etc., and conventional procedural programming languages, such as C language or similar programming languages. The computer readable program instructions may be executed partially or entirely on a computer, as an independent software, partially on a client computer and partially on a remote computer, or entirely on a remote computer or server.

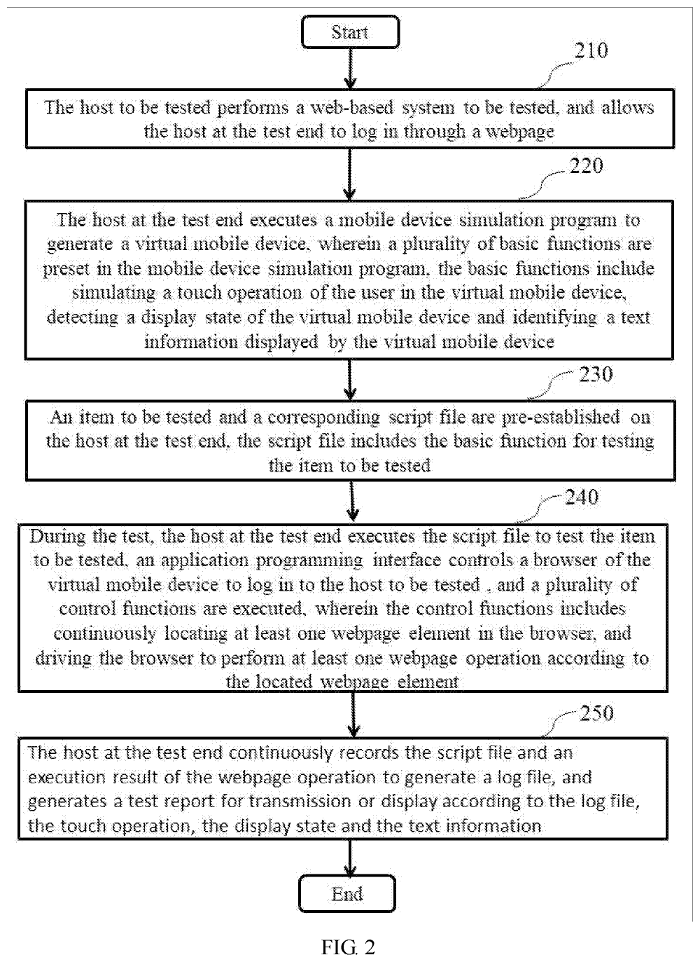

Next, referring to FIG. 2. FIG. 2 is the flow chart of a virtualized device-based test method according to the present disclosure. The method is applied to a network environment having a host to be tested 110 and a host at the test end 120. The method includes: performing a web-based test system on the host to be tested 110, and allowing the host at the test end 120 to log in through a webpage (STEP210); executing a mobile device simulation program on the host at the test end 120 to generate a virtual mobile device, and presetting a plurality of basic functions in the mobile device simulation program. The basic functions include simulating the touch operation of the user in the virtual mobile device, detecting the display state of the virtual mobile device and identifying the text information displayed by the virtual mobile device (STEP220); pre-establishing an item to be tested and a corresponding script file thereof on the host at the test end 120, the script file includes a basic function for testing the item to be tested (STEP230); executing the script file via the host at the test end 120 to test the item to be tested during the test, controlling the browser of the virtual mobile device via the host at the test end 120 to log in to the host to be tested 110 through an application programming interface, and executing a plurality of control functions. The control functions include continuously locating webpage elements in the browser, and driving the browser to perform webpage operations according to the located webpage elements (STEP240); continuously recording the script file and the execution result of the webpage operation via the host at the test end 120 to generate a log file, and generating a test report according to the log file, the touch operation, the display state, and the text information for transmission or display (STEP250). Through the above steps, a virtual mobile device can be generated by the host at the test end 120, and a script file corresponding to the item to be tested is allowed to be established. When testing, the script file is executed to simulate the touch operation, detect the display state and identify the text information by the basic functions; the browser of the virtual mobile device is driven to perform webpage operations through an application programming interface (API) and control functions; then a log file is generated according to the script file and the execution result of the webpage operations; and a test report for transmission or display is generated according to the log file, the touch operation, the display state and the text information.

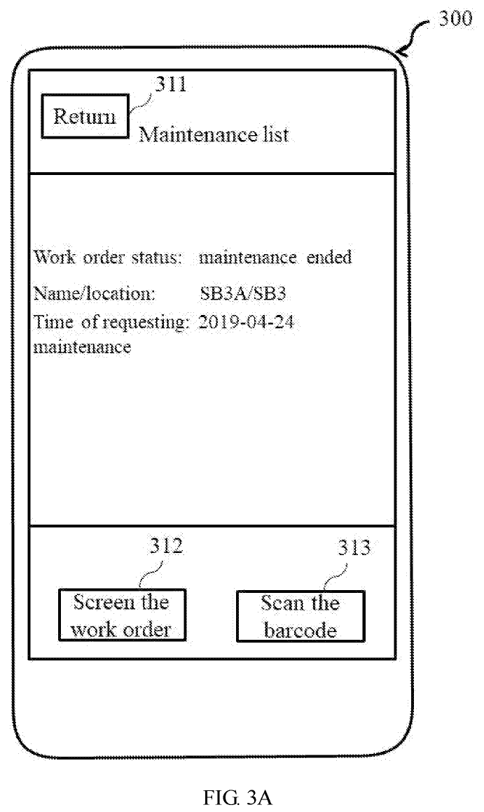

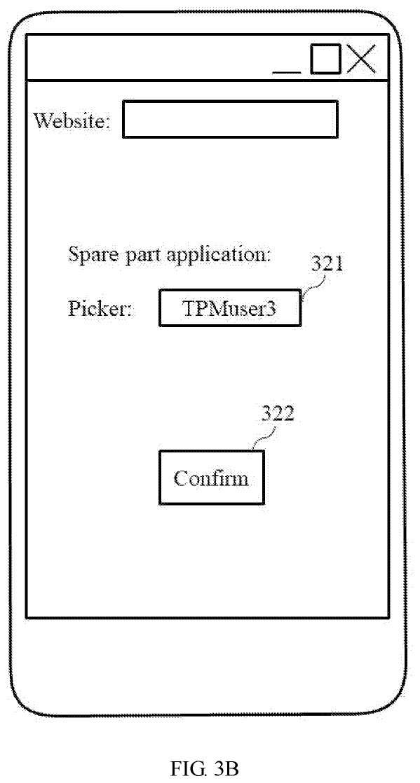

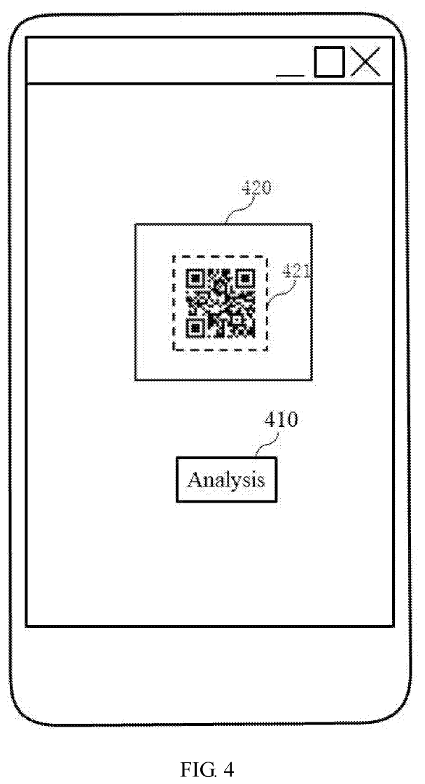

The following description will be made according to embodiments with reference to FIG. 3A to FIG. 4. Please referring to FIG. 3A and FIG. 3B first, which are schematic diagrams of applying the present disclosure for system testing. It is assumed to test a repair system (i.e. the system to be tested) provided by the host to be tested 110 to a mobile device. The host at the test end 120 of the present disclosure executes a mobile device simulation program to generate a virtual mobile device 300 as illustrated in FIG. 3A. The mobile device simulation program is preset with a plurality of basic functions for simulating the operation behavior of the user. Next, the host at the test end 120 establishes an item to be tested and a corresponding script file thereof for the user, and the user can establish corresponding script files according to different items to be tested. Taking the test of the repair system shown in FIG. 3A as an example, it is assumed that the item to be tested is whether each of the buttons (such as the return button 311, the screen-the-work-order button 312, and the scan-the-barcode button 313, etc.) can be touched normally, or whether the repair processes are correct. Then, the user may pre-establish the script file corresponding to the item to be tested through the host at the test end 120. For example, writing the script file by the basic functions to automatically perform touch-click according to the preset coordinate position. Taking test each of the buttons as an example, if the coordinate position of the return button 311 is (10, 15), the operation of the user touching and clicking the return button 311 may be simulated by the basic function “mouseClick(10, 15)”. Taking confirming the text information as an example, a control function ocrText (maintenance ended) may be executed to simulate the user verifying whether the text “maintenance ended” appears in the graphical user interface. If yes, a value of 1 is returned to indicate the occurrence; if not, then a value of 0 is returned to indicate that it has not appeared. The recognition of text is implemented by a technique of optical character recognition (OCR). At this point, the program can be designed by using different basic functions in the script file, so as to automatically simulate a series of operation behaviors of the user operating the repair system, such as clicking the button, confirming text and inputting text.

Next, as shown in FIG. 3B, when the host at the test end 120 needs to connect to the website during the test, such as connecting to the website to apply for spare parts for maintenance, it will be achieved by controlling the browser of the virtual mobile device 300 via API (e.g., “WebDriver API” and “Selenium API”) and it will continuously locate webpage elements in the browser (for example, input block 321 and confirm button 322 in the webpage), and drive the browser to perform webpage operations according to the located webpage elements. For example, the webpage element (such as the input block 321 and the determination button 322) may be first located by the control function webDrivergetElementByXPath( ), and then the positioned webpage element (that is, input Block 321) is set with text by the control function webDriver.sendKeysByXPath( ), for example, setting a picker number TPMuser3, and attempting to click on the positioned webpage element (i.e., determining button 322) by controlling the function webDrivertryClickElement( ), so that it can automatically complete web page operations such as setting text and clicking on the location of the page element. Finally, the host at the test end 120 continuously records script file and the execution result of the webpage operation to generate a log file, and generates a test report according to the log file, the simulated touch operation, the detected display state, and the recognized text information for transmission or display.

As shown in FIG. 4, FIG. 4 is a schematic diagram of applying the present disclosure to simulate the scanning of a two-dimensional barcode. In an exemplary embodiment, besides generating a virtual mobile device 300, the mobile device simulation program may further establish a virtual imaging component 420. When the user clicks the analysis button 410, the virtual imaging component 420 performs image analysis on the two-dimensional barcode 421 displayed in the virtual mobile device 300, and obtain the information embedded in the two-dimensional barcode 421, such as the website of the spare parts for maintenance and detailed information, etc. In other words, the contents in the area of the virtual imaging component 420 are the shooting content of the physical imaging component (not shown). In an exemplary embodiment, the two-dimensional barcode 421 is an image loaded under the control of the test module 123, to simulate a barcode scanned by the physical imaging component. The test module 123 may adjust the required two-dimensional barcode according to actual test needs. After the image analysis is completed, the displayed two-dimensional barcode 421 is cleared to prevent subsequent image analysis from being performed on the same two-dimensional barcode. With the virtual imaging component 420 established as described above, even if there is a flow in the item to be tested that needs to scan the two-dimensional barcode, the simulation can be smoothly performed and the test can be completed.

In summary, it can be known that the difference between the present disclosure and the existing technology is that the present disclosure generates a virtual mobile device by the host at the test end, and allows a script file corresponding to the item to be tested to be established. When testing, the script file is executed to simulate the touch operation, detect the display state and identify the text information by the basic functions; drive the browser of the virtual mobile device to perform webpage operations through an application programming interface and control functions; then generate a log file according to the script file and the execution result of the webpage operations; and generate a test report according to the log file, the touch operation, the display state and the text information for transmission or display. The above-mentioned technical means can solve the problems in the existing technology and achieve the technical effect of improving the convenience of system testing.

Although the embodiments of the present disclosure have been described above, the description is not intended to limit the scope of the present disclosure. Any person skilled in the art to which the present disclosure belongs can make some modifications in the form and details of the implementation without departing from the spirit and scope of the present disclosure. Therefore, the scope of patent protection of the present disclosure shall be subject to the scope defined in the attached claims.

What is claimed is:

1. A virtualized device-based test system, comprising:
a host to be tested, executing a web-based system to be tested, and allowing a login through a webpage;
a host at the test end, connected with the host to be tested through a network, wherein the host at the test end comprises:
a simulating module, generating a virtual mobile device by executing the mobile device simulation program, a plurality of basic functions are preset in the mobile device simulation program, the basic functions comprises simulating a touch operation of a user in the virtual mobile device, detecting a display state of the virtual mobile device and identifying a text information displayed by the virtual mobile device;
a setting module, connected to the simulating module, and pre-establishing an item to be tested and a corresponding script file on the host at the test end, the script file comprises the basic functions for testing the item to be tested;
a test module, connected to the setting module, executing the script file to test the item to be tested during a test, controlling a browser of the virtual mobile device to log in to the host to be tested through an application programming interface, executing a plurality of control functions, the control functions comprise continuously locating at least one webpage element in the browser, and driving the browser to perform at least one webpage operation according to the located webpage element; and
a generating module, connected to the test module for continuously recording the script file and an execution result of the webpage operation to generate a log file, and generating a test report for transmission or display according to the log file, the touch operation, the display state and the text information.

2. The virtualized device-based test system according to claim 1, wherein before the host at the test end tests the item to be tested, all parameters of database data, configuration files, environment parameters, basic functions and control functions in the host at the test end are initialized.

3. The virtualized device-based test system according to claim 1, wherein the mobile device simulation program establishes a virtual imaging component in the generated virtual mobile device, the virtual imaging component performs image analysis on a two-dimensional barcode displayed in the virtual mobile device to obtain the information embedded in the two-dimensional barcode.

4. The virtualized device-based test system according to claim 1, wherein the basic functions further comprise simulating a network attack for security testing, simulating a load for performance testing, and simulating heavy network traffic and user operations for stress testing.

5. The virtualized device-based test system according to claim 1, wherein the generating module embeds the test report in at least one of an email, an instant message and a webpage file, and transmits the test report to a mobile device through a network for display.

6. A virtualized device-based test method, applied to a network environment having a host to be tested and a host at the test end, the method comprises:
performing, via the host to be tested, a web-based system to be tested, and allowing the host at the test end to log in through a webpage;
executing, via the host at the test end, a mobile device simulation program to generate a virtual mobile device, wherein a plurality of basic functions are preset in the mobile device simulation program, the basic functions comprise simulating a touch operation of a user in the virtual mobile device, detecting a display state of the virtual mobile device and identifying a text information displayed by the virtual mobile device;
pre-establishing an item to be tested and a corresponding script file on the host at the test end, wherein the script file comprises the basic functions for testing the item to be tested;
during the test, executing, via the host at the test end, the script file to test the item to be tested, controlling via an application programming interface, a browser of the virtual mobile device to log in to the host to be tested, and executing a plurality of control functions, wherein the control functions comprise continuously locating at least one webpage element in the browser, and driving the browser to perform at least one webpage operation according to the located webpage element; and
continuously recording, via the host at the test end, the script file and an execution result of the webpage operation to generate a log file, and generating a test report for transmission or display according to the log file, the touch operation, the display state and the text information.

7. The virtualized device-based test method according to claim 6, wherein before the host at the test end tests the item to be tested, all parameters of database data, configuration files, environment parameters, basic functions and control functions in the host at the test end are initialized.

8. The virtualized device-based test method according to claim 6, wherein the mobile device simulation program establishes a virtual imaging component in the generated virtual mobile device, the virtual imaging component performs image analysis on a two-dimensional barcode displayed in the virtual mobile device to obtain the information embedded in the two-dimensional barcode.

9. The virtualized device-based test method according to claim 6, wherein the basic functions further comprise simulating a network attack for security testing, simulating a load for performance testing, and simulating heavy network traffic and user operations for stress testing.

10. The virtualized device-based test method according to claim 6, wherein the test report is embedded in at least one of an email, an instant message and a webpage file, and transmits the test report to a mobile device through a network for display.
